(19) United States
(12) Patent Application Publication
(10) Pub. No.: US 2003/0065741 A1
(43) Pub. Date: Apr. 3, 2003

(54) Concurrent bidirectional network communication utilizing send and receive threads

(76) Inventor: Hahn Vo, Houstin, TX (US)

Correspondence Address: AKIN, GUMP, STRAUSS, HAUER & FELD, 711 LOUISIANA STREET, SUITE 1900 SOUTH, HOUSTON, TX, 77002, US

(21) Appl. No.: 09/967,601

(22) Filed: Sep. 29, 2001

(51) Int. Cl. G06F 15/16

(52) U.S. Cl. 709/217

(57) ABSTRACT

A computer network is equipped to facilitate increased bandwidth for a large number of network data communications among a number of network devices. A software switch is configured to provide a number of ports through which data packets may be transmitted from a transmitting device to a receiving device. Each port is activated utilizing a software thread function. For each port, a port and socket is assigned and activated for communications between various identified transmitter/receiver network device pairings. Subsequent transmission between previously identified transmitter/receiver device pairings receive the same port and socket assignments as previously determined. Generation of a second layer of software thread functions are provided associated with the socket thread function to utilize the send and receive functionality of each bi-directional port. The additional layer of send and receive threads associated with a master communication thread allows simultaneous communication between transmitter/receiver device pairings across a single port. Bandwidth is effectively doubled from simultaneous messaging by utilizing both the send and receive directional capabilities of the port-socket association.

### CROSS-REFERENCE TO RELATED APPLICATIONS

Not applicable.

### STATEMENTS REGARDING FEDERALLY SPONSORED RESEARCH OR DEVELOPMENT

Not applicable.

### REFERENCE TO A MICROFICHE APPENDIX

Not applicable

### BACKGROUND OF THE INVENTION

1. Field of the Invention

The present invention generally relates to network communication and more specifically to simultaneous send and receive messages across a single socket of a network switch device.

2. Description of the Related Art

Computer networks have become increasingly complex. It is not uncommon for a single system to have a large number of network and peripheral devices coupled to communicate with one another. Further, multiple computer networks are now being strung together such that these independent computer networks can communicate with the network devices of the other networks.

Adequate communication paths has been typically managed according to standard Operating System (OS) protocols which utilize switch devices to transparently transfer a message originated by one network device intended to be received by another network device. The transmission across these switches is also performed according to known OS operating protocol. Specifically, upon the sending device sending the data, a communications or master thread is called. The master thread is a software function used by the OS to manage the communication such as various handshaking functions. Once the operating system recognizes a new message has been placed onto the network, the OS communicates with a software generated switch to determine available virtual ports across which the transmitted message may be transferred from the originating device through the switch to the receiving device. Once an available port is found, an associated socket is called and activated by either a send or a receive thread. The switch indicates to the OS that the port is dedicated for that transmission cycle to pass the initially transmitted data. As such, the port is then spoken for and cannot be used for other transmissions during the cycle.

Ports are used to provide a bi-directional communication path and to provide virtual software housekeeping to track the many messages transmitted across the network. Virtual port and port are used interchangeably to identify connections between software applications, i.e., between the OS and device drivers. For each port assignment a socket is activated by the OS. A socket is an OS defined data type. To activate a particular socket for communication, a send or a receive thread is called according to well known techniques in the art. The master thread requires that a virtual port be associated and dedicated to the activated socket.

A switch device is used to manage the sockets and the associated virtual ports. The switch is a software construct which functions to select and activate the available ports and the associated sockets. One feature of the ports is its bidirectional nature. Thus, selection of a port is not dependent on the direction of the data to be communicated. Instead, each port provides both send and receive capabilities. However, according to present techniques, once a port and an associated socket is activated there is no manner to utilize both the send and the receive functions simultaneously. Instead, once a port has been selected, that port is dedicated to one-way communication, in the direction the original communication is transmitted. In many systems, the switch construct provides for a limited number of ports, 64K ports in some systems. Thus, for more complex networks port availability is a limiting factor for bandwidth of both intra and inter network communications.

### BRIEF SUMMARY OF THE INVENTION

Briefly according to the disclosed invention, a computer network is equipped to facilitate increased bandwidth for a large number of network data communications among a number of network devices. A software switch is configured to provide a number of ports through which data packets may be transmitted from a transmitting device to a receiving device. Each port is activated utilizing a software thread function. For each port, a socket is assigned and activated for communications between various identified transmitter/receiver network device pairings. Subsequent transmission between previously identified transmitter/receiver device pairings receive the same port and socket assignments as previously determined. Generation of a second layer of software thread functions are provided associated with the master thread function to utilize the send and receive functionality of each bidirectional port. The additional layer of send and receive threads associated with each master communication thread allows simultaneous or concurrent communication between transmitter/receiver device pairings across a single port. Bandwidth is effectively doubled from simultaneous messaging by utilizing both the send and receive directional capabilities of the port-socket association.

### BRIEF DESCRIPTION OF THE SEVERAL VIEWS OF THE DRAWINGS

A better understanding of the present invention can be obtained when the following detailed description of the preferred embodiment is considered in conjunction with the following drawings, in which:

FIG. 1 is a blocked diagram of an exemplary network communication system;

FIG. 2 is a simplified diagram of the network communication system of FIG. 1;

FIG. 3 is an exemplary network communication messaging exchange according to the prior art;

FIG. 4 represents a pre-assignment table according to the disclosed invention for port assignment;

FIG. 5 is a simplified switch according to the disclosed invention for simultaneous send and receive capabilities across a port;

FIG. 6 is an exemplary implementation of the message exchange of FIG. 3 implemented according to the disclosed invention; and

FIG. 7 is a flow chart of an exemplary software process of the disclosed network communication protocol.

### DETAILED DESCRIPTION OF THE INVENTION

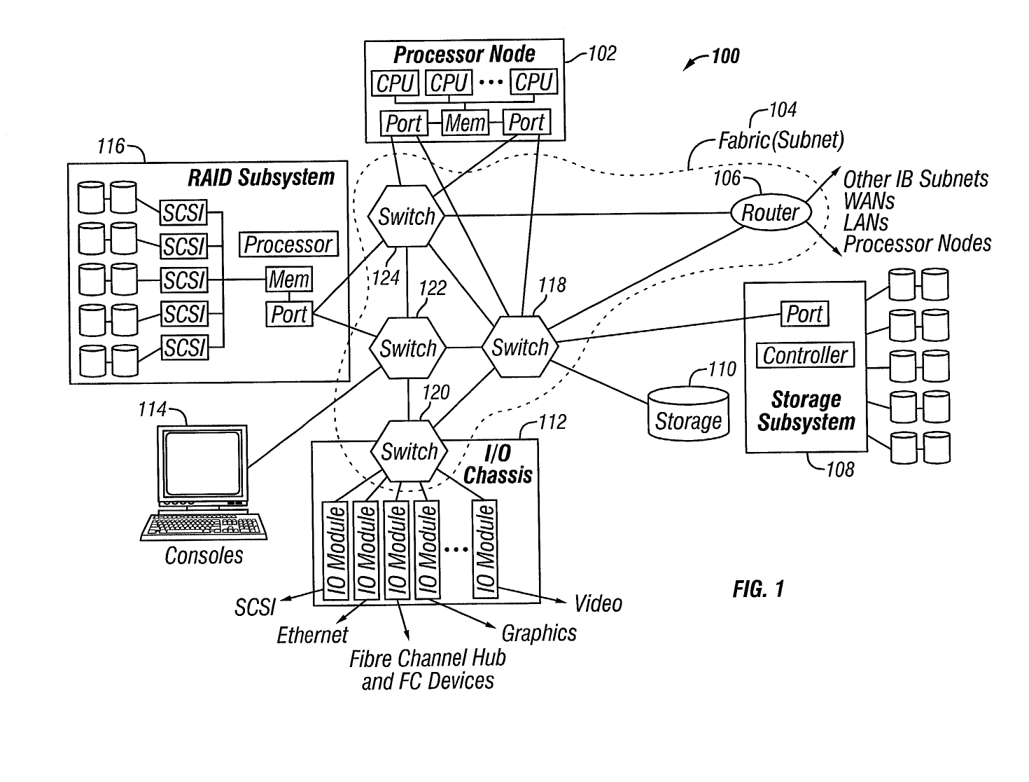

Turning now to FIG. 1, shown is a computer network 100 such as an InfiniBand™ architecture (IBA) network. The disclosed exemplary architecture may be modified to conform with any number of well-known network architectures. According to one embodiment, end node devices, such as processor node 102, memory storage system 108, and I/O subsystem 112 are interconnected by cascaded switch devices 118, 120, 122 and 124. According to an embodiment, switch devices 118, 120, 122 and 124 are compliant with the InfiniBand™ Architecture Specification, Release 1.0a. The local communication network is connected via the cascaded switches 118-124 and router 106 to form a network fabric 104 or subnet. The router 106 functions to connect the subnetwork 104 to other subnetworks, wide area networks (WAN), local area networks (LAN), or other processor nodes.

Communication among the various nodes and peripheral devices is facilitated through a switch network contained in the subnetwork fabric 104. According to one embodiment, communication packets conform to the well known Internet Protocol (IP). A switch 118-124 in the network functions to simply pass the transmitted packets from a transmitting node or address to the destination address indicated in the packet's header. Each switch effectively exposes two or more ports between which the data packets are relayed.

According to an embodiment, every node or destination within the subnetwork is identified with a unique local identifier. This local identifier represents a path through the switch according to a pre-assigned message forwarding table. Specifically, the incoming packets are forwarded through each switch 118-124 to an outbound port of the switch based on the packet's destination address, or local identifier, and the message forwarding table referenced by each switch. Thus, upon transmission of an IP data packet, a receiving switch 122, for example, reads the packet to discern the destination node and transmits the communication packet to the corresponding port according to the message forwarding table. Such destination peripherals can include any variety of peripherals other than those displayed in FIG. 1.

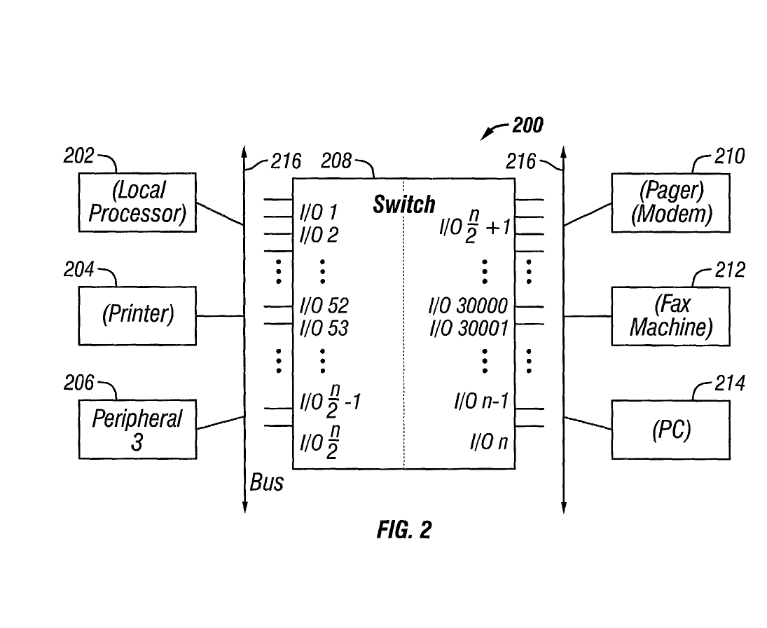

Turning now to FIG. 2, illustrated is a simplified version of the communication network of FIG. 1. According to the embodiment shown in FIG. 2, local bus lines 216 are utilized as common communication lines among the peripherals 202-206 and 210-214 and the switch 208. The bus communication line 216 is coupled to a number of input/output ports of software switch 208. Through this setup, each peripheral may communicate with any other peripheral with the switch 208 routing the communication messages. It will be understood by those skilled in the art that the switch is not a hardware switch but instead a software construct capable of many socket transmission paths. It will also be understood by those skilled in the art that the bus 216 is an over-simplified representation of bus communication over the network, but that much more complex multi-bus architectures may be employed without departing from the spirit of the disclosed invention.

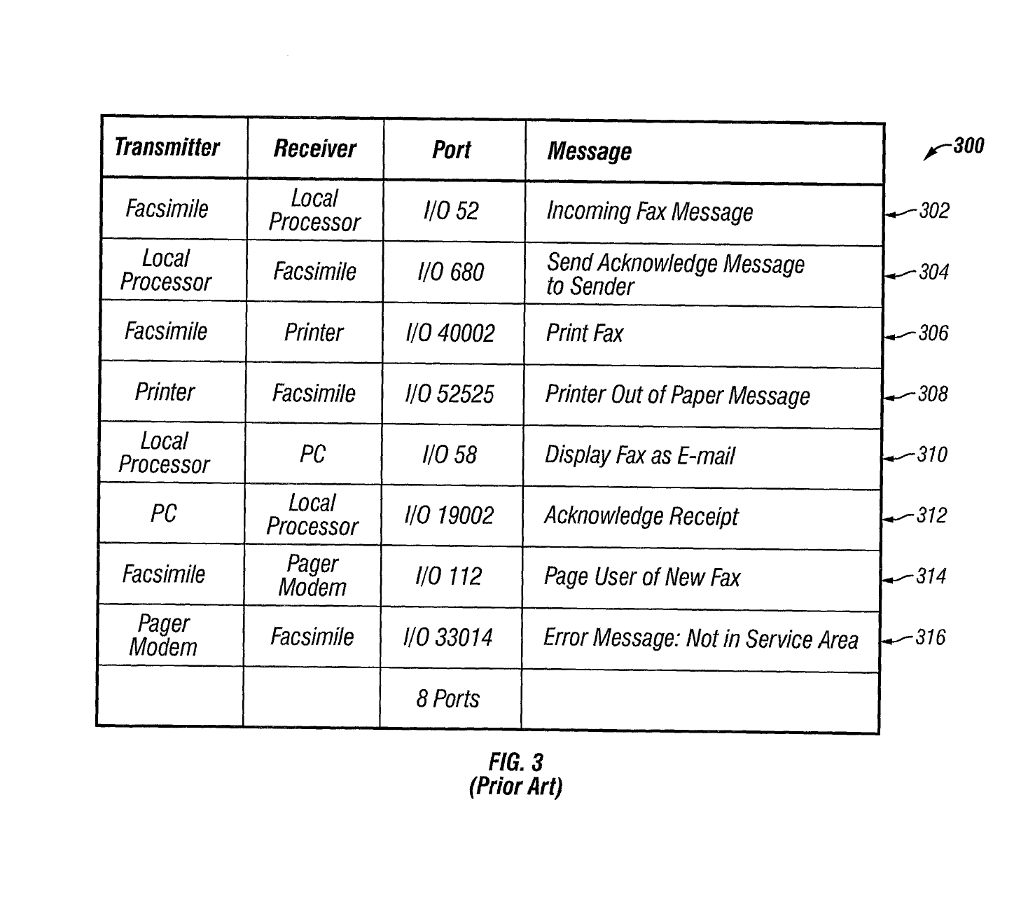

Turning to FIG. 3, shown is a very simplified exemplary communication exchange among the network peripherals illustrated in FIG. 2. According to existing established systems, a message originating from one peripheral is sent to the switch 208 into any port which is available for use. Availability is determined by the OS at the time the message is received by the switch. The switch 208 then transmits the message ports onto bus 216 through the determined available port. According to one embodiment, a typical switch may contain up to 64K ports.

Communication example 300 illustrates a prior art communication exchange in the case where simultaneous sender/receiver transmission is needed. Thus, according to one example, an incoming fax 302 is received at fax device 212. The fax message 302 is then sent to the local processor 202 across the bus 216 to a then determined available port of switch 208. For example, the operating system may determine that port 52 of switch 208 is unused. In the alternative, the switch may determine from the destination address within the data packet and cross-reference this with an internal message forwarding table identifying port 52 as the proper outgoing port.

Frequently, communication between devices occur simultaneously in both directions, i.e. from the transmitting device to the destination and vice versa, at the same time. In the past, concurrent bidirectional messages required multiple sockets. For example, simultaneous with a portion of the incoming fax message 302, the local processor may be required to send a return acknowledgement 304 back to the facsimile 212. In the instance where the incoming fax message 302 continues, a reverse or return path through port 52 from the local processor 202 to the facsimile 212 is unavailable. The OS together with the switch 208 then had to identify new unused ports of the switch 208 across which to send the return message, for example, port 680 of switch 208.

A similar exchange occurs for an exemplary chain of events occurring as a result of the incoming fax message 302. For example, the system 200 may be configured to automatically and simultaneously print the fax message 306 as it arrives at the facsimile 212. Messages must then be sent between the facsimile 212 and the printer 204. Thus, as the data is sent from the facsimile 212 to the printer 204 across an unused port of switch 208, a return simultaneous message may be required such as a message indicating the printer is out of paper 308, again across an unused port. Likewise, the system 200 may be configured to automatically display 310 the facsimile message as it arrives on an email system at the PC 214. Simultaneous return messages may likewise be necessary for the previous two communications. A similar notification may be configured on system 200 to page 314 a user to alert of the new fax. In the instance where a simultaneous return message is needed, as with the other return messages, a return path through the same ports is not available where the originating message is ongoing. Thus, the system 200 requires the need for an additional port 33014 to provide the capacity for the return error message 316. Thus, for the entire communication exchange, a total of 16 ports are required.

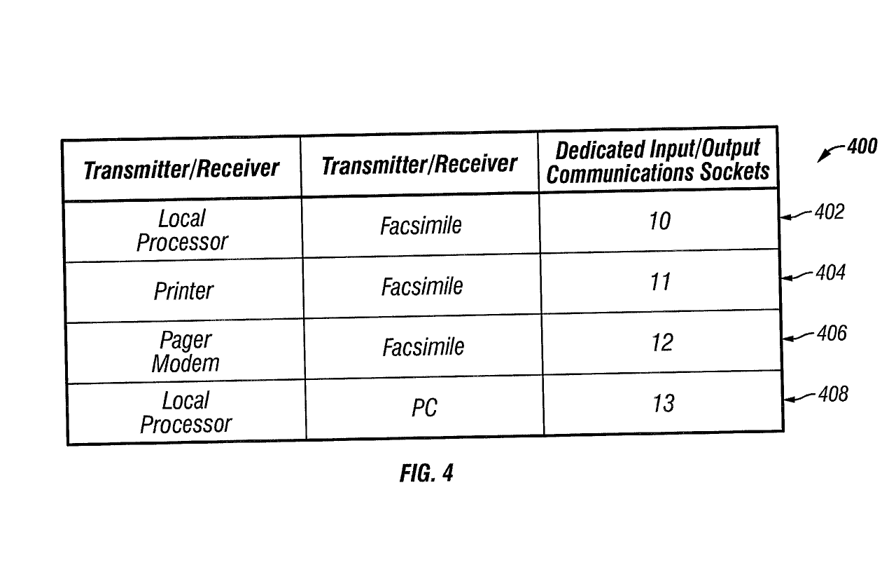

Turning now to FIG. 4, shown is an exemplary assignment 400 of transmitter/receiver pairs associated with dedicated input/output communications ports of switch 208. These pre-assignments are used by the switch 208 to determine ports used for communications between specific transmitter/receiver pairs. In a larger network system, each potential transmitter/receiver pair may be identified in the chart and pre-assigned to dedicated input/output ports of switch 208. For combinations of transmitter/receiver pairs that had not been previously pre-assigned, the default setting would allow the operating system to select communication ports of switch 208 based upon standard techniques of merely assigning the communications packet to any unused port determined at the time of the message origination. According to the disclosed invention, the pre-assigned look up table may be updated with this new assignment.

Thus, for communications between transmitter/receiver pairs that are programmed into the socket assignment table of FIG. 4, the switch knows automatically which input/output ports and associated sockets to activate for the transmission. For example, referring to line 402 of FIG. 4, a data packet identifying a message from the local processor with a destination address for the facsimile causes the OS to call a master communication thread to set up the data transmission. The switch 208 assigns either an unused or preassigned port to activate port 10. For those transmitter/receiver pairs not included in the assignment table, the system would merely pick any available open port of switch 208. The assignment table is easily programmable and is capable of modification including adding transmitter/receiver pairs at first encounter of the pair or deleting transmitter/receiver pairs at last encounter of the pair during a cycle or at the beginning of a cycle.

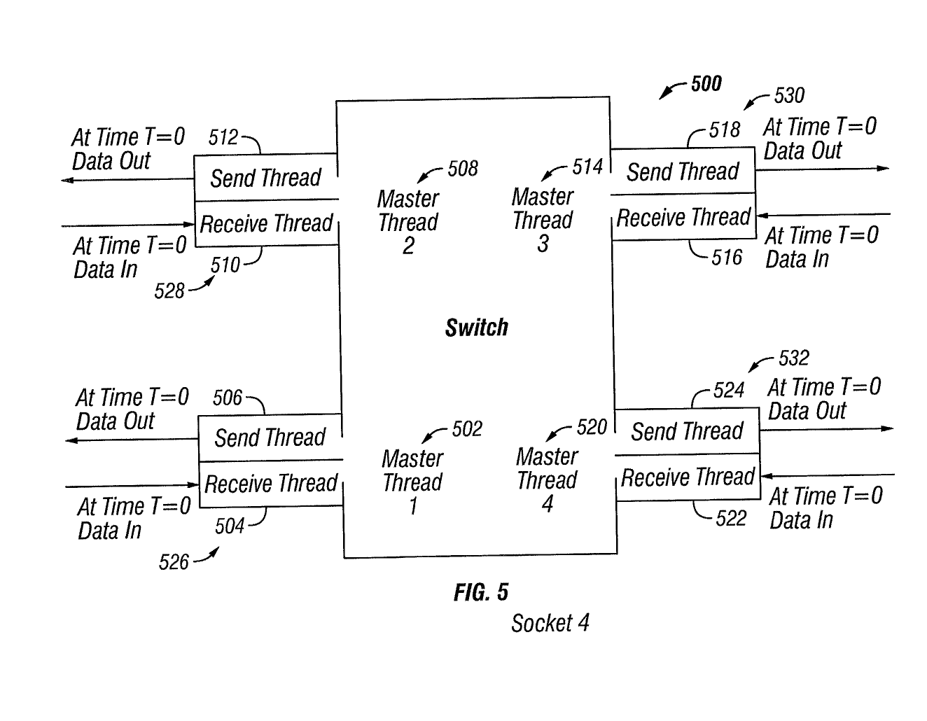

Turning to FIG. 5, shown is port utilization according to the disclosed invention. The switch 500 has been simplified to master communications threads 502, 508, 514 and 520 (master threads 1-4). According to well-known switch architecture, each master thread associates with it an available port 526, 528, 530 and 532, respectively. Each port, in turn, includes both send and receive functionality. On a per transaction basis for each port, a transmission may pass through the port in a bidirectional manner through a socket associated with the port. However, under existing systems, a port could not be used simultaneously for a send and a receive message. Specifically, once a port and assigned socket had been assigned to a particular transmission, either send or receive, the switch and the OS consider that port to be fully utilized. Thus, as described in connection with FIG. 3, in existing systems master thread 508 may establish either an incoming or outgoing message via the associated port 528 receive thread 510 or its send thread 512, respectively, but could not provide a simultaneous return path for a message in the opposite direction through the same port.

According to the disclosed invention, an additional thread layer is provided to each port and master thread pair effectively separating the ports associated send and receive paths allowing two available message paths. Thus, for example, a packet exchange between a facsimile device and a personal computer or server in a network may be assigned an incoming/outgoing dedicated slot designation of port 528 and an associated socket. This would indicate to the switch 500 that any message identifying the facsimile 212 and the PC 214 as the source and destination addresses, or vice versa, will cause port 528 and the associated socket to be activated for that particular transmission. Likewise, depending on which device is the sender and which device is the receiver, the switch 500 will call an executable send or receive thread to activate the appropriate path through the master thread and port assignment, whether it be a send path or a receive path.

Thus, for example, for communications originated by the facsimile 212 to the PC 214, the switch 500 will read the source and destination addresses from the data packet and perform a look-up operation to the socket assignment table, such as indicated in FIG. 4. The port assignment look-up table will indicate that for communications originating from the facsimile 212 to the PC 214, port 528 is the outgoing port via send thread 512. Because each port provides independent send and receive paths, return communication from the PC 214 to the facsimile 212 is provided by calling the receive thread 510 of master thread 508.

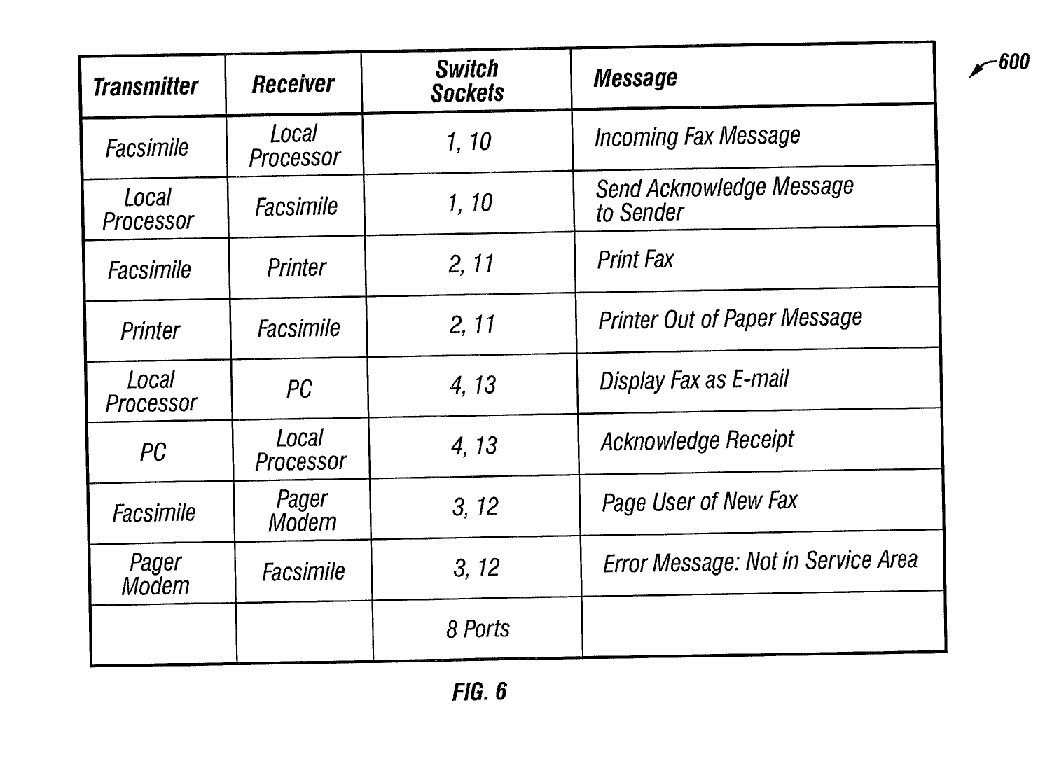

The simultaneous bidirectional capability on a per port basis is achieved by establishing a double-tier control protocol. Specifically, in addition to the master thread already established within the switch implementation, the disclosed techniques establish an additional tier for each port containing both a send thread and a receive thread. In other words, each port is called by a master communication thread, and each function of the port (send and receive) is represented by an additional subthread. The master thread is passed the port assignments from each associated send thread and receive thread. Because each thread may be executed independently, data messages across the send path of the port can occur concurrent to data messages across the receive path of the port. For example, at time=0 the receive thread 516 may transmit incoming data while, also at time=0, the send thread 518 may simultaneously transmit outgoing data. In addition, referring to the communication exchange example of FIG. 6, discussed in more detail below, responsive messages may occur at a time after time=0 but still be concurrent to opposite transmitted data that is ongoing.

Since each port can receive and send data simultaneously, a send thread is created to execute the sending operation and a receive thread is created to execute the receive operation. According to well-known techniques in the industry, the thread is responsible for executing the code contained in the processes address base. For example, a single process may contain several threads, all of them executing code simultaneously. Again, according to well-known techniques, each thread is implemented using its own set of registers and its own stack to facilitate simultaneous execution. The set of send and receive threads allows both the send and receive paths of a port to be active and capable of data transmission independently of the other path.

Turning now to FIG. 6, shown is an implementation of a message exchange in accordance with the disclosed invention, utilizing a multi-tiered thread approach for simultaneous send and receives. FIG. 6 represents application of simultaneous send and receive functions for the transmission exchange discussed in connection with FIG. 3. Thus, for communications originating from the facsimile 212 to the local processor 214, and referring back to the socket assignment table of FIG. 4, the transmitted message is sent via switch 500 port 10. At the same time or during transmission of this first message, the switch sees a response message and knows based on the pre-assignment table that this is a return message calling for execution of the receive thread on port 10. In this way, the send and receive function of the port is fully utilized for simultaneous communications between two pre-defined transmitter/receiver pairs. This protocol continues for communication between the facsimile 212 and printer 204, the local processor 202 and the PC 214, and the facsimile 212 and the pager modem 210. The result is utilization of half the number of ports required to effectuate the same sequence of facsimile transmissions compared to existing methods indicated in connection with FIG. 3. The further result of this is an increase in bandwidth by two times the number of switch ports. Thus, an existing system described in connection with FIG. 3 provides simultaneous communication messages but requires a specific port assignment for each data stream. Thus, data transmission is limited to the number of ports or 64K. According to the disclosed multi-tier thread protocol providing two independent data paths per port, that number of simultaneous messages is doubled.

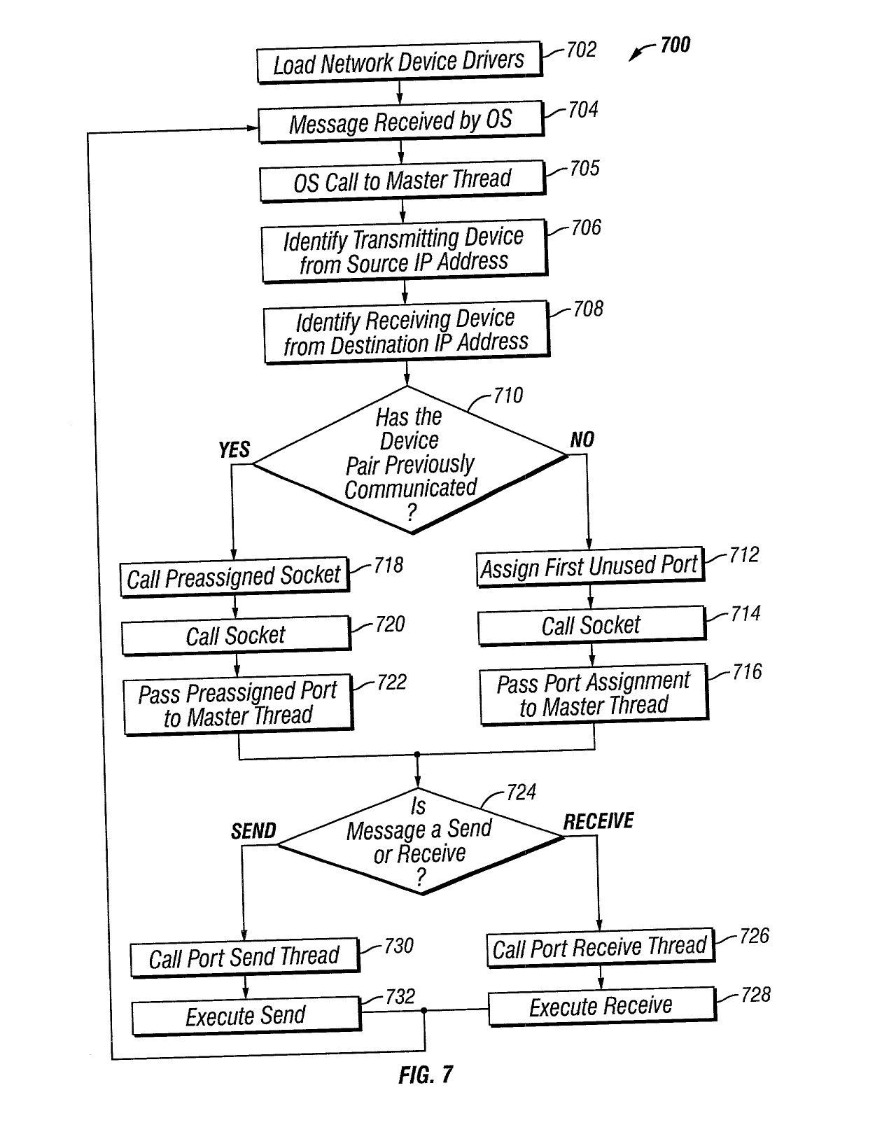

Turning now to FIG. 7, illustrated is an exemplary flow diagram for implementing simultaneous network communication using send and receive threads. Initially at step 702 the device drivers for the various network devices are loaded into the system. These device drivers may be loaded initially upon configuration of the system as well as subsequently as new devices are added or updated. At step 704 a message initiated by a network device is received by the operating system. At step 705, a master communications thread is called to handle the message transmission. At steps 706 and 708 the message in the form of a IP data packet is analyzed to identify the transmitting and receiving device addresses. At step 710, the system determines whether this network device pair has communicated before. If not, the first unused port is assigned to handle communication between the identified transmitting and receiving device pair. The associated socket is called at step 714 to activate the socket. The system then passes the assigned port to the master thread at step 716.

If communications between the transmitting and receiving device pair has occurred previously, control proceeds to step 518 where the system calls the port that had been assigned in the prior occurrence of the device pairing. At step 520 the associated socket is called to activate the socket for communication. At step 522, identification of the port that had been assigned to that socket for the device pairing is passed to the master thread. At this point, the switch 500, has been configured with the appropriate port and the associated socket activated for the transmitting and receiving device pair.

At step 724, it is determined from the message packet whether the message is a send or receive message. If the message is a receive message, then at step 726 the receive thread for the particular port is called and then executed at step 728. If the message is a send communication, then at step 730 the send thread for the particular port is called and executed at 732. The entire process 700 is recursively repeated as the OS receives new messages. In addition, the process 700 is capable of occurring simultaneously with messages received by the OS.

Thus, in accordance with the present invention, bandwidth is effectively doubled for simultaneous messaging among network devices. By predefining port assignments for communicating device pairings and by establishing a second layer of executable send and receive threads for each available port and socket pair, simultaneous forward and return messaging is effectuated.

The foregoing disclosure and description of the various embodiments are illustrative and explanatory thereof, and various changes in the type of communication network, the network devices, the switch configuration, software thread configuration and other circuitry, the organization of the components, and the order and timing of steps taken as well as in the details of the illustrated system may be made without departing from the spirit of the invention.

I claim:

1. A computer network, comprising:
a plurality of network devices;
a computer network coupled to the plurality of network devices; and
a switch coupled to the computer network, comprising:
a plurality of ports with at least one port connected to a send thread to send outgoing data and a receive thread to receive incoming data, the send thread sending the outgoing data concurrent with the receive thread receiving the incoming data.

2. The computer network of claim 1, wherein each port is connected to an active socket for network communication.

3. The computer network of claim 1, wherein the send thread and the receive thread are connected to a master communication thread.

4. The computer network of claim 1, wherein each port is connected to a send thread and a receive thread for sending and receiving data concurrently.

5. The computer network of claim 1, further comprising:
a memory for storing a pre-assigned set of dedicated ports for communications between network device pairings, wherein the set of dedicated ports for a particular network device pairing is activated by execution of a software thread associated with each of the ports of the dedicated ports when a transmitted data identifies the particular network devices pairing to which the ports are assigned.

6. The computer network of claim 5, further comprising:
a plurality of unassigned ports activated by an associated software thread when the transmitted data identifies a network device pairing not stored in memory.

7. The computer network of claim 1, wherein the switch comprises an InfiniBand™ architecture compliant switch.

8. The computer network of claim 1, wherein the send and receive threads are sub-threads associated with a master communication.

9. A method for network communication among a plurality of network devices, comprising the steps of:
executing a send thread for the port associated with a master communication thread of a switch;
executing a receive thread for the port to receive incoming data;
sending outgoing data across the port of the switch when the send thread is executed; and
receiving incoming data at the port of the switch concurrent with the send thread sending outgoing data when the receive thread is executed.

10. The method of claim 9, wherein the send thread and the receive thread are associated with the master communication thread for the associated port, the send thread and receive thread executable when the master communication thread is executed.

11. The method of claim 9, further comprising the steps of:
executing a plurality of send threads for a plurality of ports of the switch, each of the plurality of ports associated with a master communication thread of the switch; and
executing a plurality of receive threads for the plurality of ports, each of the plurality of receive threads associated with a send thread, the receive thread receiving data at the port concurrent with the send thread sending data from the port.

12. The method of claim 9, further comprising the steps of:
storing in a memory a plurality of a set of port assignments for each network device communication pairing; and
identifying the network device communication pairing which matches outgoing data from a network device; and
executing the threads associated with the stored port assignments according to the identified network device communication pairing.

13. The method of claim 12, further comprising the steps of:
locating an unassigned port when the identified network device communication pairing is not stored in the memory; and
executing a thread associated with the unassigned port.

14. The method of claim 9, wherein the switch comprises an InfiniBand™ architecture compliant switch.

15. The method of claim 9, wherein the send and receive threads are sub-threads associated with the master communication thread.

16. A switch in a computer network, comprising:
a plurality of ports, with at least one port connected to a send thread to send outgoing data and to a receive thread to receive incoming data, the send thread sending the outgoing data concurrent with the receive thread receiving the incoming data.

17. The switch of claim 16, wherein each port is connected to an active socket for network communication.

18. The switch of claim 16, wherein the send thread and the receive thread are connected to a master communication thread.

19. The switch of claim 16, wherein each port is connected to a send thread and a receive thread for sending and receiving data concurrently.

20. The switch of claim 16, further comprising:
a memory for storing a preassigned set of dedicated ports for communications between network device pairings, wherein the set of dedicated ports for a particular network device pairing is activated by execution of a software thread associated with each of the ports of the dedicated ports when a transmitted data identifies the particular network devices pairing to which the ports are assigned.

21. The switch of claim 20, further comprising:
unassigned ports activated by an associated master communication thread when the transmitted data identifies a network device pairing not stored in memory.

22. The switch of claim 17, wherein the send and receive threads are sub-threads associated with a master communication thread.
